(19) United States
(12) Patent Application Publication
(10) Pub. No.: US 2012/0117451 A1
(43) Pub. Date: May 10, 2012

(54) METHOD AND APPARATUS FOR DISPLAYING WEBPAGE

(75) Inventor: Ho Sung YOU, Gunpo-si (KR)

(73) Assignee: SAMSUNG ELECTRONICS CO. LTD., Suwon-si (KR)

(21) Appl. No.: 13/291,542

(22) Filed: Nov. 8, 2011

(30) Foreign Application Priority Data
Nov. 8, 2010 (KR) 10-2010-0110336

(51) Int. Cl. G06F 17/00

(52) U.S. Cl. 715/205

(57) ABSTRACT

A method and apparatus for displaying webpages connected to links of a first webpage are provided. The method includes displaying a first webpage having at least one link corresponding to another webpage, detecting a touch to select one of the at least one link, and loading a second webpage corresponding to the selected link in the background.

### PRIORITY

This application claims the benefit under 35 U.S.C. §119(a) of a Korean patent application filed on Nov. 8, 2010 in the Korean Intellectual Property Office and assigned Serial No. 10-2010-0110336, the entire disclosure of which is hereby incorporated by reference.

### BACKGROUND OF THE INVENTION

1. Field of the Invention

The present invention relates to a webpage display method and apparatus. More particularly, the present invention relates to a method and apparatus for displaying webpages connected to links of the currently presented webpage.

2. Description of the Related Art

With the rapid advance of information and semiconductor technologies, there has been a phenomenal growth in the use and popularity of mobile devices. Recent mobile devices are not just basic devices for providing dedicated services but have become multifunctional devices that support converged functions and services. As an example, the mobile communication terminal incorporates diverse supplementary functions including a TeleVision (TV) function, (e.g., Digital Multimedia Broadcasting (DMB) and Digital Video Broadcasting (DVB)), an audio playback function (e.g. MPEG Audio Layer-3 (MP3)), a camera function, and a data communication function as well as the basic voice communication and messaging functions.

More particularly, the mobile internet function has become an essential function of the recent mobile terminals. However, the mobile terminal has a display screen limited in size such that it is not able to display multiple webpages simultaneously. Due to the display size limitation, when a link provided on a webpage (hereinafter, referred to as first webpage) is selected, the mobile terminal replaces the first webpage with a new one corresponding to the selected link. Typically, in order to go back to the first webpage on the newly opened webpage, the user uses the go-back function.

Meanwhile, the conventional mobile terminal is provided with a new window display function for presenting the webpage corresponding to the link selection in a new window. In case that the corresponding (i.e., target) webpage (hereinafter, referred to as second webpage) is displayed in the new window, the second webpage is displayed on the top of the screen. That is, the second webpage is displayed overlapped on the first webpage such that only the second webpage is displayed. Accordingly, in order for the user to see the first webpage, it is necessary to close the second webpage or use a window move function such that the first webpage is placed on top of the second webpage. That is, the conventional webpage display method of a mobile terminal requires the user to enter the go-back command or close the currently opened webpage to return to the previous webpage, e.g. for selecting another link, resulting in cumbersome manipulation. Furthermore, such a conventional webpage display method is an inconvenience because of the loading delay that occurs whenever a switch is made between webpages.

### SUMMARY OF THE INVENTION

Aspects of the present invention are to address at least the above-mentioned problems and/or disadvantages and to provide at least the advantages described below. Accordingly, an aspect of the present invention is to provide a webpage display method and apparatus of a mobile terminal that is capable of displaying a newly requested webpage in the background while maintaining the current webpage in the foreground.

Another aspect of the present invention is to provide a webpage display method and apparatus of a mobile terminal that is capable of facilitating display of multiple linked webpages and reducing webpage loading delay.

In accordance with an aspect of the present invention, a webpage display method is provided. The method includes displaying a first webpage having at least one link corresponding to another webpage, detecting a touch to select one of the at least one link, and loading a second webpage corresponding to the selected link in the background.

In accordance with another aspect of the present invention, a webpage display apparatus is provided. The apparatus includes a radio frequency unit for transmitting a request for a first webpage and for receiving the first webpage, a display unit for displaying the first webpage having at least one link corresponding to another webpage, and a control unit for controlling, when a touch to select one of the at least one link is detected, the display unit to load a second webpage corresponding to the selected link in the background.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of a mobile terminal according to an exemplary embodiment of the present invention;

FIG. 2 is a flowchart illustrating a webpage display method of a mobile terminal according to a first exemplary embodiment of the present invention;

FIG. 3 is a flowchart illustrating a webpage display method of a mobile terminal according to a second exemplary embodiment of the present invention;

FIG. 4 is a diagram illustrating exemplary screen images corresponding to steps of the webpage display method according to the first exemplary embodiment of the present invention; and

FIG. 5 is a diagram illustrating exemplary screen images corresponding to steps of the webpage display method according to the second exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to their bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The specification and drawings are to be regarded in an illustrative rather than a restrictive sense in order to help understand the present invention. It should be obvious to those skilled in the art that various modifications and changes can be made thereto without departing from the broader spirit and scope of the invention as set forth in the appended claims.

Prior to the explanation of exemplary embodiments of the present invention, a description is made of the configuration of the mobile terminal. The present invention can be applied to any type of device having a size-limited display screen and supporting a mobile internet access function. For example, the present invention can be applied to tablet a Personal Computer (PC), a Portable Multimedia Player (PMP), a Smartphone, an electronic book reader, and the like.

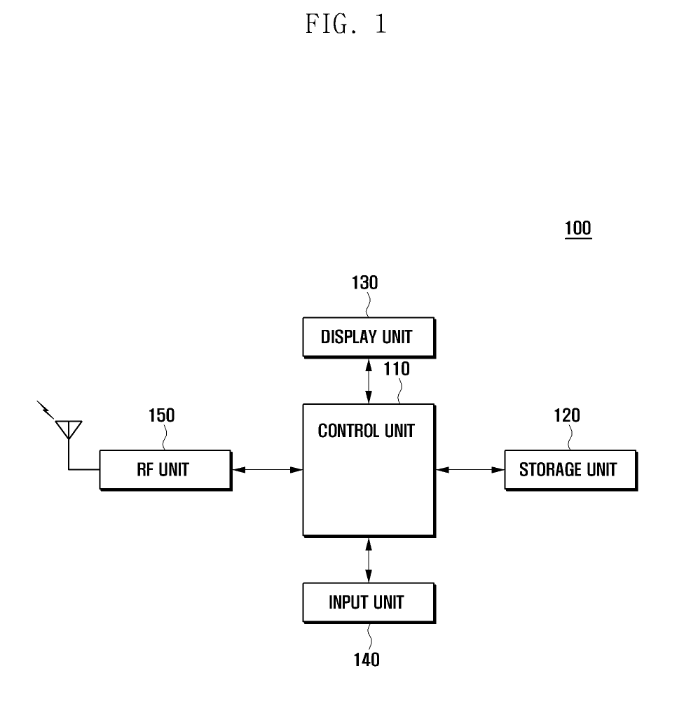

FIG. 1 is a block diagram illustrating a configuration of a mobile terminal according to an exemplary embodiment of the present invention.

Referring to FIG. 1, the mobile terminal 100 includes a control unit 110, a storage unit 120, a display unit 130, an input unit 140, and a Radio Frequency (RF) unit 150.

The input unit 140 generates input signals of various numeric and alphabetic information and related to the configuration and execution of various functions of the mobile terminal 100 to the control unit 110. For this purpose, the input unit 140 includes a plurality of alphanumeric keys for input of alphanumeric information and function keys for setting and executing the functions of the mobile terminal 100. The function keys can include navigation keys, side keys, and shortcut keys configured to execute specific functions. For example, the input unit 140 can include keys for making and ending a call and holding the call. The input unit 140 can be implemented with at least one of a touchpad, a touchscreen, a normal key array keypad, and a QWERTY keypad.

The RF unit 150 is responsible for establishing a radio channel with a base station for voice and data communications. The RF unit 150 can transmit and receive the voice and video signals to and from a counterpart terminal over the communication channel under the control of the control unit 110. The RF unit 150 can include an RF transmitter (not shown) for up-converting and amplifying the signal to be transmitted, an RF receiver (not shown) for low noise amplifying and down-converting the signal received by an antenna, and a duplexer (not shown) for isolating the transmission and reception from each other. More particularly, in an exemplary embodiment of the present invention, the RF unit 150 can transmit a webpage access request signal and receive the webpage data to be displayed on the display unit 130. For this purpose, the RF unit 150 can transmit Uniform Resource Locator (URL) information to the base station and receive the webpage data corresponding to the URL information.

The display unit 130 displays menu screens of the mobile terminal 100 and the information input by or to be provided to the user. For example, the display unit 130 can display various video data screens related to the operation of the mobile terminal 100, e.g. a standby screen, a message composition screen, and a call progress screen. More particularly in an exemplary embodiment of the present invention, the display unit 130 can display a webpage (hereinafter, referred to as first webpage) having at least one link to another webpage. When a link is selected on the first webpage, the display unit 130 can load the webpage (hereinafter, referred to as second webpage) targeted by the link on background. If another link is selected on the first webpage, the display unit 130 loads the webpage (hereinafter, referred to as third webpage) targeted by the link in the background. According to an exemplary embodiment of the present invention, the display unit 130 loads the webpages targeted by the links selected from the first webpage in the background in series.

The display unit 130 can be configured such that, when a touch is made on a specific link over a predetermined period, a popup window prompting to select an option menu item is displayed. The option menu item can include new window display, background load, and bookmark option menu items. The popup window-based option menu item presentation is described later in more detail. The display unit 130 can be implemented with one of a Liquid Crystal Display (LCD), Organic Light Emitting Diodes (OLEDs), and Active Matrix OLEDs (AMOLEDs).

The storage unit 120 can store programs necessary for operating the functions according to an exemplary embodiment of the present invention and user data. For example, the storage unit 120 can store the programs for controlling the operations of the mobile terminal 100, an Operating System (OS) for booting the mobile terminal 100, and application programs necessary for playing multimedia contents and executing other optional functions, e.g., a camera function, an audio playback function, a still and motion picture playback function, and a short range wireless communication function. The storage unit 120 also can store the data, such as audio data, generated as a result of the operation of the mobile terminal 100. More particularly, in an exemplary embodiment of the present invention, the storage unit 120 can store a program for controlling such that at least one webpage (e.g., a second webpage and a third webpage) targeted by the link selected from the first webpage as the background pages is displayed in the background of the first webpage. The storage unit 120 can include a Cache Memory (not shown) for storing the at least one webpage temporarily.

The control unit 110 can control the overall operation of the mobile terminal 100 and signaling among the internal function blocks. More particularly, in an exemplary embodiment of the present invention, the control unit 110 can control to display the webpage (first webpage) to which at least one other webpage is linked. As an example, the first webpage can be the main webpage of a portal site.

If a webpage targeted by the link on the first webpage is requested, i.e. the link is selected or touched on the screen, the control unit 110 controls the display unit 130 to load the target webpage in the background. That is, the control unit 110 can control such that at least one linked webpage is loaded in the background while maintaining the foreground display of the first webpage.

According to another exemplary embodiment of the present invention, the control unit 110 can determine when a touch made on a specific link of the first webpage is maintained over a predetermined period. If the touch is not maintained over the predetermined period, the control unit 110 controls such that the linked webpage is displayed in place of the first webpage. Otherwise, if the touch is maintained over the predetermined period, the control unit 110 controls such that a popup window prompting selection of an option menu item related to the linked webpage is displayed. The option menu item can include a new window display option, a background load option, and a linked page URL bookmark option.

In case that the new window display option is selected in the popup window, the control unit 110 can control such that the linked webpage is displayed as the foreground page in place of the first webpage. In case that the linked page URL bookmark option is selected in the popup window, the control unit 110 can extract the URL of the linked webpage and add the URL to the bookmark list. In case that the background load option is selected, the control unit 110 controls such that the linked webpage is loaded in the background.

Although the description is directed to the case where the webpages (e.g. second and third webpages) linked to the first webpage are loaded in the background in the form of new windows, the present invention is not limited thereto. For example, the control unit 110 can store the linked webpages in the cache memory rather than load them in the background such that, when the first webpage is closed, the second webpage is displayed and, when the second webpage is closed, the third webpage is displayed.

Although the description is directed to the case where the webpages linked to the first webpage are loaded in the background, the present invention is not limited thereto. For example, when at least one of the webpages registered with the bookmark list is requested in the state where the first webpage is displayed, the control unit 110 can control such that the webpages selected from the bookmark list are loaded in the background.

According to an exemplary embodiment of the present invention, the linked webpages are loaded in the background while the first webpage is displayed in the foreground, it is not necessary for the user to use the go-back function to select another webpage linked on the first webpage. That is, the user can select at least one link on the first webpage in series and see the webpages of the at least one selected link in series.

In the webpage display method according to an exemplary embodiment of the present invention, the webpages of the links selected on the current webpage are loaded as background webpages relative to the current webpage in a cumulative manner such that the user can see the webpages one by one in selected order whenever the foreground webpage is closed.

Although not shown in FIG. 1, the mobile terminal 100 can further include at least one of a camera module for capturing still and motion pictures, a broadcast receiver module for receiving broadcast signal, a display audio playback module such as an MP3 module, a short range wireless communication module for short range radio communication, an approaching sensor module for sensing approach of an object, etc. Although it is impossible to enumerate all the functional components that can be converged in the mobile terminal, the mobile terminal 100 according to an exemplary embodiment of the present invention can include at least one of the aforementioned components and their equivalents selectively.

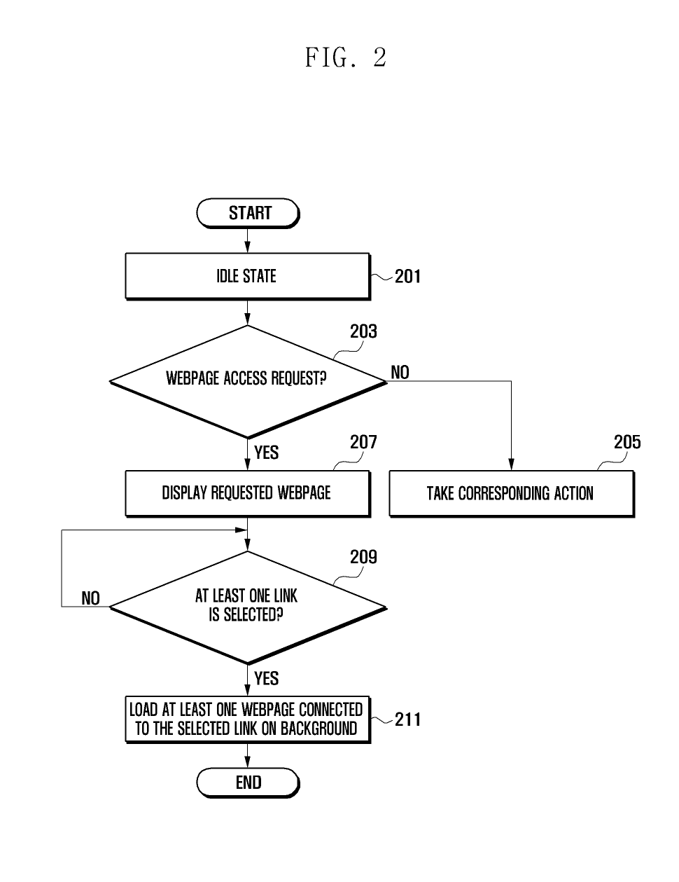

FIG. 2 is a flowchart illustrating a webpage display method of a mobile terminal according to a first exemplary embodiment of the present invention.

Referring to FIGS. 1 and 2, the control unit 110 determines that the mobile terminal 100 is in idle state in step 201. In the idle state, the control unit 110 is monitoring to detect a user input and, if a user input is detected, determines whether the user input is a webpage access request in step 203. The webpage access request can be generated by an internet access key input made by means of the input unit 140 or a touch input made on an internet access menu item displayed on the touchscreen.

If the user input is not the webpage access request, the control unit 110 takes an action corresponding to the user input in step 205. For example, the control unit 110 can maintain the idle state or execute an audio playback function, a photographing function, a short range wireless communication function, and the like. If the user input is the webpage access request, the control unit 110 controls such that the webpage is downloaded and displayed on the display unit 130 in step 207. In order to display the webpage, the control unit 110 retrieves the URL information of the requested webpage, transmits the URL information to the base station by means of the RF unit 150, receives the data of the webpage from the base station by means of the RF unit 150, and decodes the data to display the corresponding webpage (hereinafter, referred to as first webpage) by means of the display unit 130. The first webpage can include at least one link to another webpage. As an example, the first webpage can be the main webpage of a portal site.

While the first webpage is displayed, the control unit 110 is monitoring to detect a link selection command made on one of the at least one link of the first webpage in step 209. The control unit 110 continues monitoring until the link selection command is detected. If the link selection command is detected, the control unit 110 controls such that the webpage connected to the link on which the link selection command is made is loaded in the background in step 211. In more detail, when a touch is made to a first link on the first webpage, the control unit 110 retrieves the URL of the webpage (hereinafter, referred to as second webpage) connected to the first link, receives the second webpage, and loads the second webpage in the background. Afterward, when a second link is selected on the first webpage, the control unit 110 retrieves the URL of the webpage (hereinafter, referred to as third webpage) connected to the second link, receives the third webpage, and loads the third webpage in the background. Since the webpages selected by the user are accumulated as the background webpages relative to the first webpage, the user can select a plurality of links of the first webpage in series. Unlike the proposed webpage display method, the conventional webpage display method displays the webpage connected to the link selected from the first webpage in the foreground, such that there is a need of returning to the first webpage to select another link on the first webpage. Accordingly, the webpage display method according to an exemplary embodiment of the present invention facilitates selecting a plurality of webpages linked to the first webpage, resulting in improvement of user convenience and reductions of multiple link selection time.

In case that a plurality of links are selected, when a webpage is displayed in the foreground, the other webpage is loaded in the background such that, when the foreground webpage is closed, the webpage loaded in the background is displayed as a new foreground webpage immediately. This gives an effect that the loading time of a webpage is saved in view of the user.

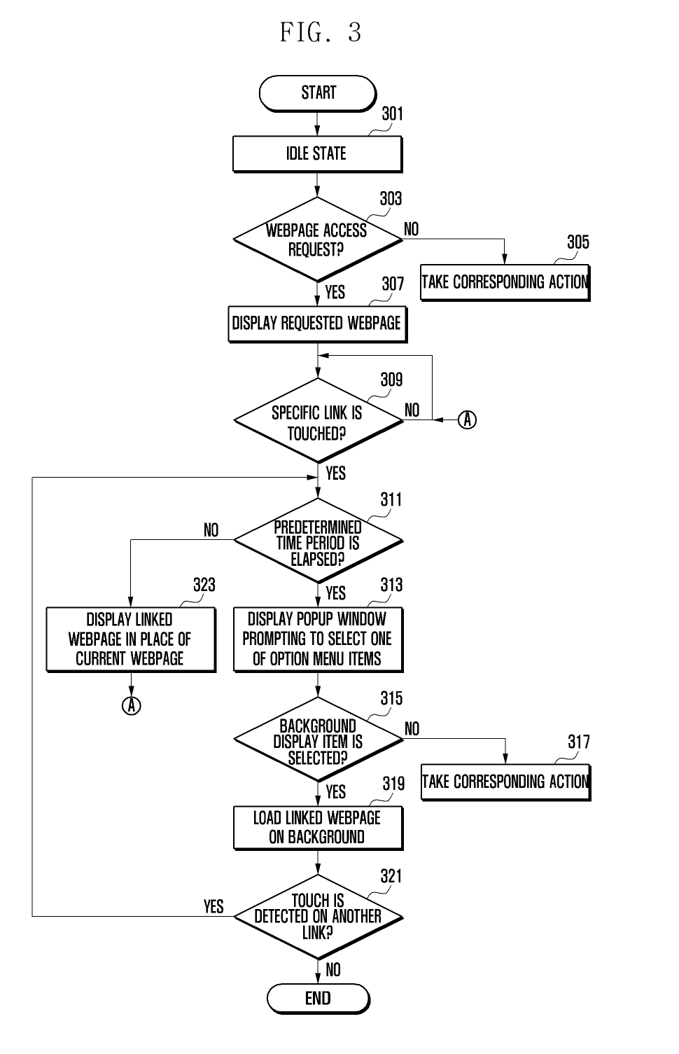

FIG. 3 is a flowchart illustrating a webpage display method of a mobile terminal according to a second exemplary embodiment of the present invention.

Referring to FIGS. 1 and 3, the control unit 110 determines that the mobile terminal 100 is in an idle state in step 301. In the idle state, the control unit is monitoring to detect a user input and, if a user input is detected, determines whether the user input is a webpage access request in step 303. The webpage access request can be generated by an internet access key input made by means of the input unit 140 or a touch input made on an internet access menu item displayed on the touchscreen.

If the user input is not the webpage access request, the control unit 110 takes an action corresponding to the user input in step 305. For example, the control unit 110 can maintain the idle state or execute an audio playback function, a photographing function, a short range wireless communication function, and the like. If the user input is the webpage access request, the control unit 110 controls such that the webpage is downloaded and displayed on the display unit 130 in step 307. In order to display the webpage, the control unit 110 retrieves the URL information of the requested webpage, transmits the URL information to the base station by means of the RF unit 150, receives the data of the webpage from the base station by means of the RF unit 150, and decodes the data to display the corresponding webpage (hereinafter, referred to as first webpage) by means of the display unit 130. The first webpage can include at least one link to another webpage. As an example, the first webpage can be the main webpage of a portal site.

While the first webpage is displayed, the control unit 110 is monitoring to detect a touch made to a specific link on the first webpage in step 309. The control unit 110 continues monitoring until a touch is detected on the first webpage. If a touch is detected on a specific link of the first webpage, the control unit 110 determines whether the touch is maintained over a predetermined time period in step 311. That is, the control unit 110 determines whether the time of the touch made to the link is equal to or longer than the predetermined time period. If the touch is not maintained over the predetermined time period, the control unit 110 replaces the current webpage (hereinafter, referred to as first webpage) with the webpage connected to the selected link (hereinafter, referred to as second webpage) on the screen in step 323. After displaying the second webpage, the control unit 110 returns to step 309. This means that the control unit 110 is monitoring to detect another touch made to a specific link on the second webpage.

If the touch is maintained over the predetermined time period, the control unit 110 controls to display a popup window prompting to select an option menu item related to the link in step 313. The option menu item can include one or more of a ‘new window display’ item for displaying the linked webpage in a new window, a ‘background load’ item for displaying the linked webpage as a background webpage to the currently displayed webpage, a ‘bookmark add’ item for registering the linked webpage with the bookmark list, and the like.

In the state that the popup window is presented, the control unit 110 is monitoring to detect a user input to select an option menu item and, if a user input is detected, determines whether the user input is to select the background load item in step 315. If the user input is not to select the background load item, the control unit 110 takes an action corresponding to the user input in step 317. For example, if the user input is to select the new window display item, the control unit 110 controls such that the linked webpage (second webpage) is displayed in the foreground. If the user input is to select the bookmark add item, the control unit 110 retrieves the URL information of the linked webpage and adds the URL to the bookmark list.

Otherwise, if the user input is to select the background load item at step 315, the control unit 110 controls such that the second webpage connected to the selected link is loaded in the background in step 319.

The control unit 110 monitors to detect a touch made to a specific link on the first webpage in step 321. If a touch is detected on a specific link of the first page, the control unit 110 repeats the steps as described above. In this manner, the mobile terminal 100 can process a plurality of webpages linked to the first webpage as the background webpages relative to the first webpage as the foreground webpage. The webpage display method according to the second exemplary embodiment of the present invention can provide the similar effect as in the first exemplary embodiment. In the second exemplary embodiment, the webpage display method of the present invention is provided along with the conventional webpage display method such that the user can select one of the webpage display modes.

Although the description is directed to the case where webpages (e.g. second and third webpages) linked to the first webpage are loaded in the background in the form of new windows, the present invention is not limited thereto. For example, the control unit 110 can control such that the linked webpage requested with background load option is stored in a cache memory and displayed immediately when the first webpage is closed. For this purpose, it is preferred that the control unit 110 or the storage unit 120 includes a cache memory for storing the data of the webpages connected to the links selected on the currently displayed webpage temporarily.

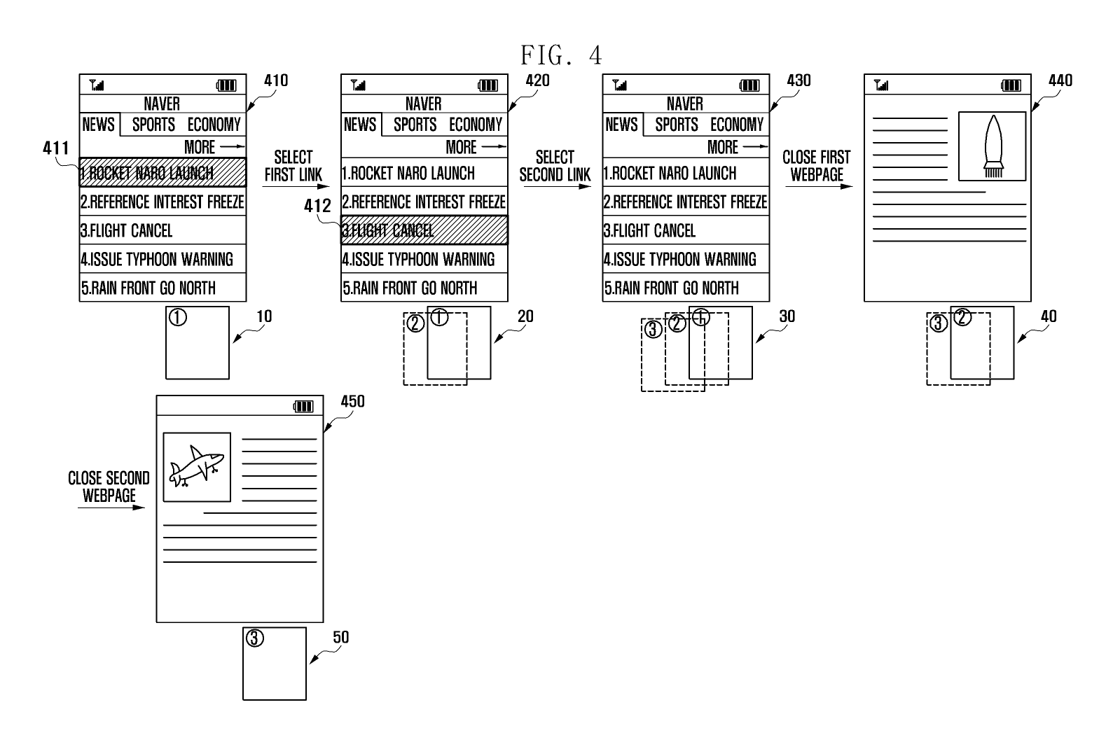

FIG. 4 is a diagram illustrating exemplary screen images corresponding to steps of the webpage display method according to the first exemplary embodiment of the present invention.

Referring to FIGS. 1 and 4, the display unit 130 can display the first webpage as shown in the screen image 410 in response to a user request. In the state where the first webpage is displayed as shown in the screen image 410, if the first link 411 is selected, the control unit 110 can display the second webpage connected to the first link 411 in the background. At this time, since the second webpage is processed as the background webpage, the display unit 130 can continue displaying the first webpage in the foreground as shown in the screen image 420. This means that, although only the first webpage is exposed to the user on the screen, the first and second webpages are loaded on the display unit 130 as denoted by reference number 20.

In the state where the first and second webpages are loaded as shown in the screen image 420, if a second link 412 is selected on the first webpage, the control unit 110 can load the third webpage connected to the second link 412 in the background. At this time, since the third webpage is processed as the background webpage relative to the second webpage, the display unit 130 can continue displaying the first webpage in the foreground as shown in the screen image 430. This means that, although only the first webpage is exposed to the user on the screen, the first to third webpages are loaded on the display unit 130 as denoted by reference number 30.

In the state where the first to third webpages are loaded as shown in the screen image 430, if the first webpage is closed by the user, the display unit 130 displays the second webpage in the foreground immediately as shown in the screen image 440. This means that the second webpage is displayed in the foreground along with the third webpage loaded in the background as denoted by reference number 40.

In the state where the second webpage is displayed in the foreground as shown in the screen image 440, if the second webpage is closed by the user, the display unit 130 displays the third webpage as the foreground webpage immediately as shown in the screen image 450. This means that the third webpage is displayed as the foreground webpage without any webpage loaded in the background as denoted by reference number 50. Although not depicted in FIG. 4, if a go-back function or a cancel function is executed in the state where the second webpage or the third webpage is displayed, the control unit 110 can control the display unit 130 such that the currently displayed webpage is replaced by the previous webpage. In case that a link is selected on the second or third webpage, the control unit 110 can control such that the webpage connected to the link selected on the second or third webpage is loaded at the bottom background.

The webpage display method according to an exemplary embodiment of the present invention is capable of selecting and loading a plurality webpages linked on one webpage in series, resulting in improvement of user convenience. This is because the webpage display method of the present invention negates the step of returning to the previous page for selecting another link. Also, the webpage display method according to an exemplary embodiment of the present invention is capable of loading the webpages connected to the links selected on the current webpage in a cumulative manner such that whenever the foreground webpage (e.g. second webpage) is closed, the background webpage (e.g. third webpage) accumulated right before is displayed immediately. This gives an effect that the loading time of a webpage is saved in view of the user.

It is noted that the objects as denoted by reference numbers 10 to 50 are depicted to help understand the subject matter of the present invention but not actually displayed on the screen of the display unit 130.

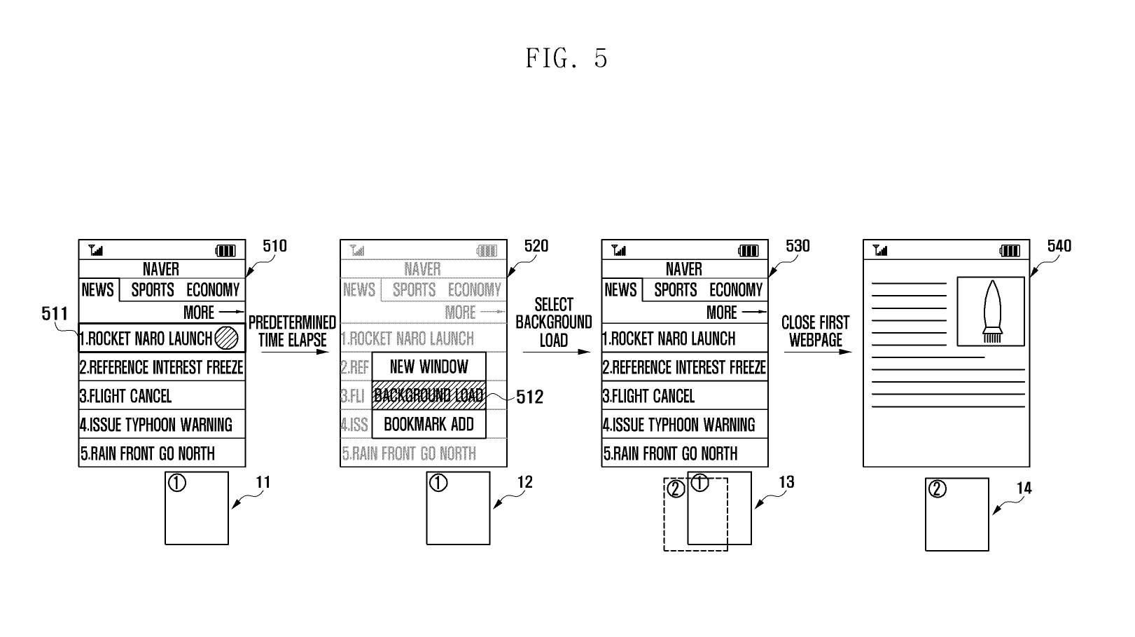

FIG. 5 is a diagram illustrating exemplary screen images corresponding to steps of the webpage display method according to the second exemplary embodiment of the present invention.

Referring to FIGS. 1 and 5, the display unit 130 can display the first webpage as shown in the screen image 510 in response to a user request. The first webpage can be a portal site including a plurality of links. Display of the first webpage is denoted by reference number 11. In the state where the first webpage is displayed as shown in the screen image 510, if a touch is made to the third link 511 on the screen over a predetermined period, the display unit 130 displays a popup window 512 prompting the user to select an option menu item listed therein under the control of the control unit 110. As denoted by reference number 12, only the first webpage is displayed at this time. If the user selects the background load option menu item in the popup window as shown in the screen image 520, the display unit 130 can display the webpage connected to the third link in the background as shown in the screen image 530. This means that the second webpage connected to the third link is loaded in the background while the first webpage is displayed in the foreground of the display unit 130, as denoted by reference number 13.

In the state where the second webpage is loaded in the background as shown in the screen image 530, if the first webpage is closed in response to the user request, the second webpage is displayed on the screen of the display unit 130 immediately as shown in the screen image 540. This is denoted by reference number 14. Although not depicted in FIG. 5, if a go-back function or a cancel function is executed in the state where the second webpage is displayed, the control unit 110 can control the display unit 130 such that the second webpage is replaced by the first webpage.

It is noted that the objects as denoted by reference numbers 11 to 14 are depicted to help understand the subject matter of the present invention but not actually displayed on the screen of the display unit 130.

Although the description is directed to the case where the at least one webpage linked to the first webpage is loaded in the background in the exemplary embodiments of FIGS. 4 and 5, the present invention is not limited thereto. For example, when at least one of the webpages registered with the bookmark list is requested in the state where the first webpage is displayed, the control unit 110 can control such that the webpages selected from the bookmark list are loaded in the background

As described above, the webpage display method and apparatus according to exemplary embodiments of the present invention is capable of loading the webpages connected to the links selected on current webpage in the background in a cumulative manner such that the user can see the webpages in series without a loading delay. Also, the webpage display method and apparatus according to exemplary embodiments of the present invention negates the step of returning to the previous webpage for selecting another link, resulting in improvement of user convenience.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A webpage display method, the method comprising:
displaying a first webpage having at least one link corresponding to another webpage;
detecting a touch to select one of the at least one link; and
loading a second webpage corresponding to the selected link in the background.

2. The method of claim 1, wherein the detecting comprises presenting, when the touch is maintained over a predetermined time period, a popup window prompting to select an option menu item.

3. The method of claim 2, wherein the option menu item comprises at least one of a new window display item for displaying the second webpage in a new window, a bookmark add item for adding the second webpage to a bookmark list, and a background load item for loading the second webpage in the background.

4. The method of claim 2, wherein the detecting comprises displaying, when the touch is not maintained over the predetermined time period, the second webpage in place of the current webpage.

5. The method of claim 1, wherein the loading comprises one of:
forming the second webpage as a new window; and
storing the second webpage in a cache memory.

6. The method of claim 1, further comprising displaying, when the first webpage is closed, the second webpage.

7. The method of claim 6, further comprising redisplaying, when a go-back function or a cancel function is executed, the first webpage in place of the second webpage.

8. The method of claim 1, further comprising:
detecting another touch to select another one of the at least one link; and
loading a third webpage corresponding to the selected other link in the background.

9. The method of claim 8, further comprising displaying, when the first webpage and the second webpage are closed, the third webpage.

10. A webpage display apparatus, the apparatus comprising:
a radio frequency unit for transmitting a request for a first webpage and for receiving the first webpage;
a display unit for displaying the first webpage having at least one link corresponding to another webpage; and
a control unit for controlling, when a touch to select one of the at least one link is detected, the display unit to load a second webpage corresponding to the selected link in the background.

11. The apparatus of claim 10, wherein the control unit controls displaying, when the touch is maintained over a predetermined time period, a popup window prompting to select an option menu item.

12. The apparatus of claim 11, wherein the option menu item comprises at least one of a new window display item for displaying the second webpage in a new window, a bookmark add item for adding the second webpage to a bookmark list, and a background load item for loading the second webpage in the background.

13. The apparatus of claim 11, wherein the control unit controls displaying, when the touch is not maintained over the predetermined time period, the second webpage in place of the first webpage.

14. The apparatus of claim 10, further comprising a cache memory for storing the second webpage.

15. The apparatus of claim 10, wherein the display unit displays, when the first webpage is closed, the second webpage.

16. The apparatus of claim 15, wherein the control unit controls redisplaying, when a go-back function or a cancel function is executed, the first webpage in place of the second webpage.

17. The apparatus of claim 10, wherein the control unit controls loading, when a webpage is selected from a bookmark list, the selected webpage in the background.

18. The apparatus of claim 10, wherein the control unit controls, when a touch to select another one of the at least one link, the display unit to load a third webpage corresponding to the selected other link in the background.

19. The apparatus of claim 18, wherein the control unit controls displaying, when the first webpage and the second webpage are closed, the third webpage.
